(19) United States
(12) Patent Application Publication
(10) Pub. No.: US 2023/0217229 A1
(43) Pub. Date: Jul. 6, 2023

(54) LOCATION TRACKING FOR EMERGENCY CALLS

(71) Applicant: CenturyLink Intellectual Property LLC, Broomfield, CO (US)

(72) Inventors: Daniel W. PEELE, Pensacola, FL (US); Kimberly ADAMS, Westerville, OH (US); Karen Levensaler ERASMI, Plymouth, MA (US)

(73) Assignee: CenturyLink Intellectual Property LLC, Broomfield, CO (US)

(21) Appl. No.: 18/055,612

(22) Filed: Nov. 15, 2022

Related U.S. Application Data
(60) Provisional application No. 63/266,488, filed on Jan. 6, 2022.

(51) Int. Cl. H04W 4/90; H04W 4/029; H04W 60/00; H04W 8/18

(52) U.S. Cl. CPC H04W 4/90; H04W 4/029; H04W 60/00; H04W 8/18

(57) ABSTRACT

Systems and methods for detecting a location change of a phone and prompting an end-user to update the phone's location when the location change is detected are provided. Detection of the location change may be based on a change in network location information associated with a device. For example, when detecting a change in network location information for a device, an end-user may be notified and/or prompted to update address information for the device.

### CROSS-REFERENCE TO RELATED APPLICATIONS

This application claims the benefit of U.S. Provisional Application No. 63/266,488 filed Jan. 6, 2022, entitled “Location Tracking for Emergency Calls,” which is incorporated herein by reference in its entirety.

### BACKGROUND

Federal laws and regulations in the United States, including Kari's Law and Section 506 of Ray Baum's Act, impact information communicated during emergency calls (e.g., during a 911 call). In particular, Kari's Law includes notifying emergency responders when an emergency call is made. The Ray Baum's Act includes identifying dispatchable locations of devices used to place emergency calls. As defined in Ray Baum's Act, a “dispatchable location” is a location delivered with an emergency call “that consists of the validated street address of the calling party, plus additional information such as suite, apartment or similar information necessary to adequately identify the location of the calling party.” 47 C.F.R. § 9.3. The rules regarding dispatchable location apply to any multi-line telephone system (MLTS) that is manufactured, imported, offered for first sale or lease, first sold or leased, or installed in the United States.

It is with respect to these and other general considerations that the aspects disclosed herein have been made. Also, although relatively specific problems may be discussed herein, it should be understood that the examples should not be limited to solving the specific problems identified in the background or elsewhere in this disclosure.

### SUMMARY

Examples of the present disclosure describe systems and methods for location tracking of a phone based on network information. In an aspect, a computer-implemented method for location tracking of a device for emergency calls is described. The method includes receiving a first set of network location information from a device and logging the first set of network location information in a log. The method further includes receiving a second set of network location information from the device. Additionally, the method includes comparing the first set of network location information with the second set of network location information and determining that the first set of network location information is different from the second set of network location information. In response to determining that the first set of network location information is different from the second set of network location information, the method includes sending a notification to verify address information for the device.

In an example, the method further includes logging the second set of network location information in the log. In another example, the method further includes: in response to the notification to verify the address information for the device, receiving address information for the device; and logging the address information in the log in association with the second set of network location information. In a further example, the first set of network location information is associated with a first registration period of the device and the second set of network location information is associated with a second registration period of the device different from the first registration period. In yet another example, the first registration period immediately precedes the second registration period for the device. In still a further example, the first set of network location information and the second set of network location information each include one or more of: a virtual local area network (VLAN) identifier; a local internet protocol (IP) address; a basic service set identifier (BSSID); or switch information. In another example, the log includes at least one previously logged set of network location information associated with verified address information. In a further example, the method further includes: comparing the second set of network location information with the previously logged set of network location information; and determining that the second set of network location information is different from the previously logged set of network location information.

In another aspect, a computer-implemented method for location tracking of a device for emergency calls is described. The method includes receiving a first set of network location information from a device and logging the first set of network location information in a log, wherein the log further includes a set of previously logged network location information different from the first set of network location information and wherein the set of previously logged network location information is associated with address information. The method further includes receiving a second set of network location information from the device. Additionally, the method includes comparing the second set of network location information with the first set of network location information and the previously logged set of network location information and determining that the second set of network location information is the same as the set of previously logged network location information. The method also includes associating the second set of network location information with the device and the address information and logging the second set of network location information in the log.

In an example, the second set of network location information is received from the device consecutively after the first set of network location information. In another example, the device is a first device and wherein the set of previously logged network location information is associated with a second device. In a further example, the method further includes: receiving first device identification information from the first device; and receiving first device identification information from the second device, wherein association of the second set of network location information with the first device is based on the first device identification information and association of the second set of network location information with the second device is based on the second device identification information. In yet another example, the address information is validated. In still a further example, the address information is a dispatchable location of the device.

In a further aspect, a computer-implemented method for location tracking of a device for emergency calls is described. The method includes registering a device during a first registration period. In response to registering the device, the method includes sending first instructions to the device to cause the device to send a first set of network location information to a server, wherein the first set of network location information is associated with the first registration period. The method also includes determining that the device is no longer registered and re-registering the device during a second registration period. In response to re-registering the device, the method includes sending second instructions to the device to cause the device to send a second set of network location information to the server, wherein the second set of network location information is associated with the second registration period. Based on the first set of network location information and the second set of network location information being different, the method includes sending a prompt to the device to update address information associated with the device.

In an example, the first registration period immediately precedes the second registration period. In another example, sending the prompt to the device is further based on an indication received from the server. In a further example, the prompt is one of: a voice call to the device; an audio file to be played by the device; or a visual indicator displayed by the device. In yet another example, the method further includes receiving address information from the device, in response to the prompt. In still a further example, the method further includes: validating the address information; and updating the address information for the device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 depicts a system 100 for location tracking for emergency calls.

FIG. 2 depicts a schematic of example floor plans of a building and locations of devices about the floor plans.

FIG. 3 depicts an example operating environment.

FIG. 4 depicts an example method for device-location tracking for emergency calls, from a perspective of a calling device.

FIG. 5 depicts another example method for device-location tracking for emergency calls, from a perspective of an application server.

FIG. 6 depicts another example method for device-location tracking for emergency calls, from a perspective of a location-tracking server.

### DETAILED DESCRIPTION

As described above, laws and regulations involve notifying emergency responders when an emergency call is made and identifying a dispatchable location of devices used to place emergency calls. As defined in Ray Baum's Act, a “dispatchable location” is a location delivered with an emergency call “that consists of the validated street address of the calling party, plus additional information such as suite, apartment or similar information necessary to adequately identify the location of the calling party.” 47 C.F.R. § 9.3. Regarding devices that are on-premises and non-fixed, such as voice over internet protocol (VoIP) phones and internet protocol (IP) phones, an automated dispatchable location must be provided when technically feasible. Otherwise, either of the following must be provided: (1) a dispatchable location based on end-user manual update, or (2) alternative location information. Alternative location information must be sufficient to identify the caller's civic address and approximate in-building location, including the floor level, in large buildings. 47 CFR §§ 9.16(b)(3)(ii), 9.3.

Considering these laws and regulations with respect to on-premises, non-fixed phones, determination of a dispatchable location is a technical challenge. These phones often may be moved about a building or premises without capability to otherwise self-determine their specific location. To comply with the aforementioned laws and regulations, however, the on-premises, non-fixed phones must still provide one of the following: (1) a dispatchable location based on end-user manual update, or (2) alternative location information. In devices that are not capable of self-determining a specific location, alternative location information can be determined based on an end-user manual update.

Thus, on-premises, non-fixed phones may stay in compliance with emergency caller information by requesting that an end-user manually update the dispatchable location of the device when the device is moved (e.g., if the dispatchable location of the device changes). Detecting when a device has moved location is also a challenge when a device is not capable of self-identifying its location. Additionally, reliance on wire mapping of ports in a building may be unreliable or not specific enough to comply with dispatchable location standards. Further, redundant or unnecessary prompting of an end-user to update a device location would likely lead to a poor user experience, end-user frustration, and overburdening of computing resources (e.g., a network or application requesting and/or receiving end-user location information).

Solutions to these circumstances may include automatically detecting a location change of a phone and prompting an end-user to update the phone's location when the location change is detected. Detection of the location change may be based on a change in network location information associated with a device. For example, when detecting a change in network location information for a device, an end-user may be notified and/or prompted to update address information for the device. Accordingly, systems and methods for location tracking for emergency calls are provided.

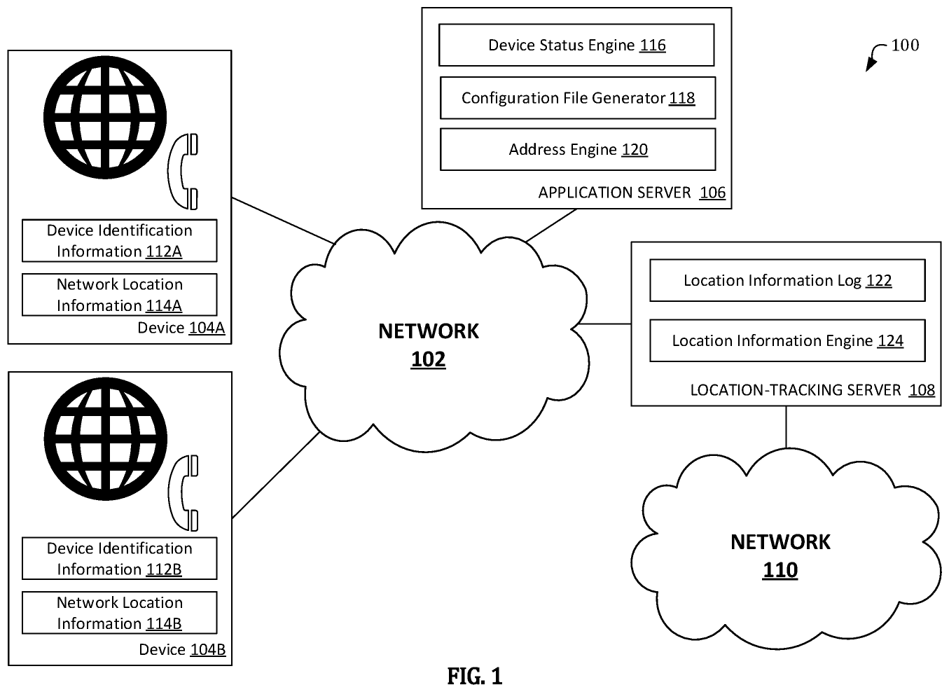

FIG. 1 depicts a system 100 for location tracking for emergency calls. As shown, the system 100 includes a network 102, a first device 104A, a second device 104B, an application server 106, a location-tracking server 108, and another network 110.

The network 102 may be a private network 102. Alternatively, the network 110 may be a different private network 110 or a public network 110 (e.g., the Internet). The networks 102, 110 may include other components or devices not shown in FIG. 1. For example, the networks 102, 110 may include other servers or devices, test points, routers, gateways, switches, ports, hubs, bridges, modems, repeaters, access points, etc. These network components (not shown) may be connected to each other and/or to other devices or servers connected to the networks 102, 110 (such as first device 104A, second device 104B, application server 106, and/or location-tracking server 108), via a wired or wireless connection. Components of the networks 102, 110 and devices and servers connected to the networks 102, 110 may communicate over the networks 102, 110 and may pass traffic between each other over the networks 102, 110.

The devices 104A, 104B are capable of placing emergency calls over the network 102. The devices 104A, 104B are installed on, and interface with, the network 102. In examples, the devices 104A, 104B are each one of an IP phone, VoIP phone, or analog terminal adapter (ATA). In a specific example, a device may be a Polycom® phone. The devices 104A, 104B may be associated with location-tracking information. The location-tracking information includes device identification information 112A, 112B specific to identification of the devices 104A. 104B, such as a phone number, serial number, device identifier, media access control (MAC) address, etc. The device identification information 112A, 112B may be specific to each device 104A, 104B and may not change over time or physical location. Thus, the device identification information 112A, 112B may be used to identify a device 104A, 104B (e.g., identification of the device 104A, 104B by an application server 106 and/or location-tracking server 108). The location-tracking information for the devices 104A, 104B also includes network location information 114A, 114B. The network location information 114A, 114B may include a virtual local area network (VLAN) identifier, local IP address, basic service set identifier (BSSID), switch information, ethernet port, network port, or other information associated with connectivity of the device 104A, 104B to the network 102. Although two devices 104A, 104B are shown in the system 100 in FIG. 1, any number of devices may be connected to the network 102, such as one device or three or more devices. Additionally, the devices 104A, 104B may also include other components not shown in FIG. 1, such as drives, processors, memory, power supplies, adapters, network interface cards, etc. Additionally, the devices 104A, 104B may be connected to, or comprise, other computing devices, such as a computer (not shown).

The application server 106 may manage the devices 104A, 104B over the network 102. For example, the application server 106 may manage calls from the devices 104A, 104B over the network 102 and/or facilitate communications between the devices 104A, 104B over the network 102. In an instance, the application server 106 may use a session initiation protocol (SIP). SIP may act as a VoIP protocol in an instance where a device 104A, 104B is a VoIP phone or IP phone. The application server 106 may include a device status engine 116, a configuration file generator 118, and an address engine 120.

The device status engine 116 of the application server 106 may determine if a device 104A, 104B is online (e.g., turned on and connected to the network 102). When the device 104A, 104B is online, the device 104A, 104B may be registered with the application server 106. A device may continue to have registration status or online status with the application server 106 until the device 104A, 104B is disconnected from the network 102, turned off, or otherwise not able to communicate with the application server 106. The period during which a device is registered without becoming unregistered is referred to herein as a registration period. When a device is no longer able to communicate with the application server 106, the device status becomes unregistered or offline. The device status engine 116 of the application server 106 may determine status of a device 104A, 104B via pinging of any registered device, which may be continuous or periodic. For instance, a registered or online device is a device which continues to answer the ping and an unregistered or offline device is a device that fails to answer one or more (e.g., a specified number of) consecutive pings.

The application server 106 may also communicate with other servers or devices regarding device status of one or more devices 104A, 104B. For example, the application server 106 may communicate with the location-tracking server 108, discussed below, regarding device status and/or a change in device status. If the device status engine 116 of the application server 106 determines a change in device status, an alert may be sent from the application server 106 to the location-tracking server. For example, if a registered device becomes unregistered, an alert may be sent from the application server 106 to the location-tracking server 108 communicating the status change. As further described below, the location-tracking server 108 may query the device, based on the alert. In some examples, the application server 106 and location-tracking server 108 may be combined into a single server, device, system, and/or computing cluster.

Upon registration or re-registration of a device 104A, 104B with the application server 106, the configuration file generator 118 of the application server 106 may compile and/or send a configuration file to the registered device. The configuration file may include instructions to be carried out by the device. For example, the configuration file may instruct the device 104A, 104B to retrieve device identification information 112A, 112B and network location information 114A, 114B for the current registration period, such as a local IP address, set a VLAN identifier, a MAC address, and/or other configuration information associated with the device, network, and/or application server. Additionally, the configuration file may instruct the device to communicate with other devices and/or servers, such as the location-tracking server 108. Communication between the device 104A, 104B and the location-tracking server 108 may be instructed during each registration (e.g., each time a device connects to the network 102) or may be based on an alert by the application server 106. For example, if the application server has created an alert associated with the device (e.g., the device was previously registered, became unregistered, and is currently re-registering), the application server may include instructions in a configuration file for the device to communicate with the location-tracking server 108.

The application server 106 may also include an address engine 120. In an example, each device 104A, 104B is associated with an address (e.g., a dispatchable location for device location during an emergency call). The address may be specified in address information by a user of a device, may be received from the device, and/or may be received from the location-tracking server 108. The address associated with a device may be stored by the address engine 120 at the application server 106. Additionally or alternatively, the address may be validated and/or verified by the address engine 120 of the application server 106. For example, an address received for a device may be validated for accuracy and/or cross-checked against a list of valid dispatchable locations prior to associating the address with a device.

The application server 106 may also include other components not shown in FIG. 1, such as drives, processors, memory, power supplies, adapters, network interface cards, etc. For example, the application server 106 may also include a communication engine for communicating with users of a device 104A, 104B. For instance, the application server 106 may send instructions to a device to instruct a user to update an address associated with the device. In examples, the instructions may execute on the device as an audio recording, phone call, visual indicators displayed on a display of a device, etc. The communication engine may communicate with a device separately from, or in combination with, instructions sent in a configuration file from the configuration file generator 118.

The location-tracking server 108 may communicate with one or more devices and/or servers on the network 102. In an example, the location-tracking server may use a TR069 protocol. For instance, the location-tracking server 108 may be a gateway, router, computer, or any other device capable of implementing a TR069 protocol. In other examples, the location-tracking server 108 may be cloud-hosted. The location-tracking server 108 may be on or off a premises of the devices 104A, 104B and/or the application server 106. Although the location-tracking server 108 as shown as being connected to the same network 102 as the application server 106 and the devices 104A, 104B, the location-tracking server may be supported under a different infrastructure, such as on a different network (e.g., network 110 or another network not shown, which may be shared with the application server 106).

The location-tracking server may determine if a device 104A, 104B on the network 102 has changed its dispatchable location. In an instance, the location-tracking server 108 may automatically determine a change in a device's dispatchable location based on a change in network location information (e.g., VLAN identifier, local IP address, BSSID, switch information, or other information associated with connectivity of the device 104A, 104B to the network 102). The location-tracking server 108 may identify a device 104A, 104B based on device identification information 112A, 112B and may detect a change in a device's location based on network location information 114A, 114B. As shown in FIG. 1, the location-tracking server 108 may include a location information log 122 and a location information engine 124. Additionally, the location-tracking server 108 may include other components not shown in FIG. 1, such as drives, processors, memory, power supplies, adapters, network interface cards, etc.

The location information log 122 may store or log network location information associated with a device (e.g., in a log). The network location information associated with each device may include the immediately preceding network location information associated with the prior registration period of the device with the application server 106 (e.g., network location information received for consecutive registration periods of a device). Additionally or alternatively, the location information log 122 may store multiple sets of network location information, which may be associated with that device or any other device. For example, during a first registration period of a device, a first set of network location information may be logged in the location information log 122, during a second registration period of the device, a second set of network location information may be logged in the location information log 122, during a third registration period of the device, a third set of network location information may be logged in the location information log 122, etc. Each set of network location information for the device may further be associated with address information (e.g., a dispatchable location for the device) in the location information log 122. Continuing the previous example, assuming that each set of network location information logged for the device is different, the first set of network location information for the device may be associated with a first dispatchable location, the second set of network location information for the device may be associated with a second dispatchable location, and the third set of network location information for the device may be associated with a third dispatchable location, etc. Table 1, below, includes an example of this storage regime.

TABLE 1

| | Device | | Associated |
|---|---|---|---|
| Network Location | Identification | Temporal | Dispatchable |
| Information | Information | Indicator | Location |
| Set 1 | Device 1 | Current | Unknown |
| Set 2 | Device 2 | Current | Unknown |
| Set 3 | Device 1 | Immediately | Address 3 |
| | | Preceding | (Validated for Set 3) |
| Set 4 | Device 2 | Immediately | Address 4 |
| | | Preceding | (Validated for Set 4) |
| Set 5 | Device 1 | Previously | Address 5 |
| | | Logged | (Validated for Set 5) |
| Set 6 | Device 1 | Previously | Address 6 |
| | | Logged | (Validated for Set 6) |
| Set 7 | Device 2 | Previously | Address 7 |
| | | Logged | (Validated for Set 7) |

The location information log 122 includes at least the network location information from the immediately preceding registration of the device (e.g., the network location information associated with the most recent registration of the device). In an example in which multiple sets of network location information are stored in the location information log 122 for a device, the sets of network location information may be stored, organized, and/or otherwise prioritized based on how recent the set of network location information was logged for that device. For instance, the location information log 122 may store a limited quantity of sets of network location information for device, which may be based on how recent the set of network location information was logged (e.g., storage of the last five sets, ten sets, 25 sets, etc.).

As described above, the location information log 122 stores at least the immediately preceding network location information in associated with each device. Other sets of network location information logged prior to the immediately preceding network location information for a device may not be stored and/or may be stored without association with a device. For example, the location information log 122 may store first network location information associated with a first device from the first device's most recent registration period and may also store second network location information associated with a second device from the second device's most recent registration period. Sets of network location information from the first device and/or the second device predating the most recent registration period of either device may be stored without associated with a specific device and may be associated with a dispatchable location. A dispatchable location associated with a set of network location information may be sent from the application server 106 to the location-tracking server 108 to update the location information log 122 after receiving address information from the device 104A, 104B. Table 2, below, includes an example of this storage regime.

TABLE 2

| | Device | | Associated |
|---|---|---|---|
| Network Location | Identification | Temporal | Dispatchable |
| Information | Information | Indicator | Location |
| Set 1 | Device 1 | Current | Unknown |
| Set 2 | Device 2 | Current | Unknown |
| Set 3 | Device 1 | Immediately | Address 3 |
| | | Preceding | (Validated for Set 3) |
| Set 4 | Device 2 | Immediately | Address 4 |
| | | Preceding | (Validated for Set 4) |
| Set 5 | N/A | Previously | Address 5 |
| | | Logged | (Validated for Set 5) |
| Set 6 | N/A | Previously | Address 6 |
| | | Logged | (Validated for Set 6) |
| Set 7 | N/A | Previously | Address 7 |
| | | Logged | (Validated for Set 7) |

As the associated dispatchable location is updated at the address engine 120 of the application server 106, the application server 106 may send the address to the location-tracking server 108 for updating at the location information log 122 (e.g., an “Unknown” dispatchable location may be updated to an address for later reference by the location-tracking server 108).

Network location information 114A, 114B or a set of network location information for a device, during a registration period (e.g., a period during which a device has uninterrupted registration status with the application server 106), may be received by the location-tracking server 108 from the device 104A, 104B. Additionally, device identification information 112A, 112B for a device, during a registration period, may be received by the location-tracking server 108 from the device 104A, 104B. As described herein, a device 104A, 104B may be instructed to communicate network location information 114A, 114B and/or device identification information 112A, 112B to the location-tracking server 108 upon registration and/or re-registration with the application server 106 (e.g., as instructed via a configuration file sent from the application server 106 to the device 104A. 104B). Alternatively, a device 104A, 104B may receive a query from the location-tracking server 108 to provide network location information, based on a status change alert sent from the application server 106 to the location-tracking server 108.

A device 104A, 104B may be identified by the location-tracking server 108 based on device identification information 112A, 112B. As network location information is received by the location-tracking server 108, the location-tracking server 108 may use the location information engine 124 to determine if an address of the device has changed. A determination that an address of a device has changed may be based on a change in network location information for an identified device between the current registration period of the device and the last known set of network location information (e.g., the immediately preceding network location information associated with the device). To determine or detect that an address of a device has changed, the location information engine 124 of the location-tracking server 108 may compare the current network location information received from a device with the immediately preceding network location information associated with the device (e.g., as stored in the location information log) (e.g., see Table 1 or Table 2, above).

If the current network location information received from the device matches the immediately preceding network location information for the device, then the location-tracking server 108 may determine that an address of the device is unchanged, without a need to be updated. If, alternatively, the current network location information received from the device is different than the immediately preceding network location information for the device (e.g., any one or more pieces of information of the network location information does not match, such as a different VLAN identifier, local IP address, BSSID, switch information, etc.), then the location-tracking server 108 determines that an address of the device may have changed.

If the location-tracking server 108 determines that an address of the device may have changed, the location-tracking server 108 may compare the current network location information of the device against other stored sets of network location information (e.g., other than the immediately preceding network location information for that device). The location-tracking server 108 may determine an address for the current network location information by comparing the current network location information against previously logged sets of network location information associated with a known address, for any device (e.g., for a same or different device than the device identified by the current device identification information). For example, the current network location information may be compared against previously logged sets of network location information for that device (e.g., for Device 1 in Table 1, Set 5 and Set 6) or may be compared against all previously logged sets of network location information, regardless of device association (e.g., for Device 1 in Table 1, Sets 4-7; for Device 1 in Table 2, Sets 4-7). If the current network location information matches a previously logged set of network location information associated with an address, stored in the location information log 122, then the location-tracking server 108 may determine the address information of the device without otherwise prompting an address update at the device (e.g., the same address as the matching set of network location information). For example, a first device (identified using first device identification information) may be previously located at a first location (determined based on network location information) associated with a first address (e.g., as verified by a user of the device or is otherwise known) and a second device may be previously located at a second location associated with a second address. If the first device moves to the second location and the second device moves to the first location, then the location-tracking server 108 may determine the first device is currently at the second address and the second device currently at the first address. This determination may be made by the location-tracking server 108 by comparing the current network location information for the first device with previously logged network location information for the second device. Additionally or alternatively, when the location-tracking server 108 determines that an address of the device may have changed, regardless of determining an address from logged network location information, the location-tracking server 108 may send instructions to the application server 106 to prompt retrieval of address information from the device.

The application server 106, upon receiving instructions from the location-tracking server 108, may communicate with the device to prompt a user of the device to update an address associated with the device. In an example, the prompt may be a voice call to the device, prompting the device to play an audio file saved at the device, a display of a prompt or visual indicator at a display of the device, etc. In an instance, a voice call or audial prompt may recite information such as, “We've detected that your phone has moved, please update your address.” The address may then be updated by a user of the device, in response to the prompt, via a portal associated with the application server 106, verbally in response to a voice call, via button selection (e.g., a touch screen, buttons, or otherwise at a display of a device), or other feedback provided by the user to the application server 106. The application server 106 may then verify and/or validate the address provided from the device, which may include receiving further verification from the device. After updating the address for the device at the address engine 120 of the application server 106, the application server 106 may send feedback or a receipt to the device confirming that the address is updated.

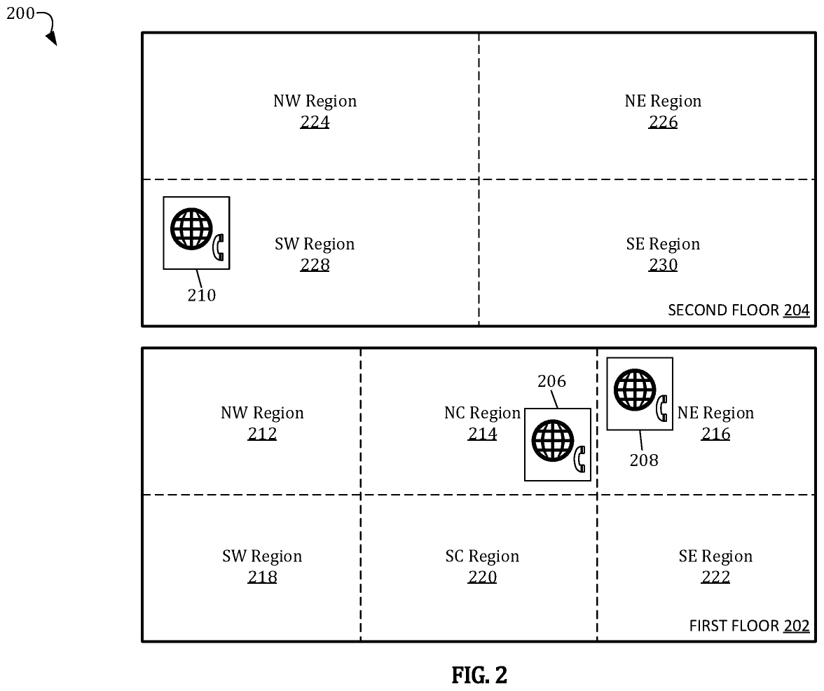

FIG. 2 depicts a schematic of example floor plans of a building 200 and locations of calling devices 206, 208, 210 about the floor plans. In the example shown in FIG. 2, a building 200 includes at least two floors (e.g., a first floor 202 and a second floor 204). Three calling devices 206, 208, 210 are located on one of the first floor 202 or second floor 204 of the building 200. The calling devices 206, 208, 210 may be similar to the devices 104A, 104B described above with respect to FIG. 1. Specifically, the calling devices 206, 208, 210 may be VoIP phones, IP phones, or ATAs. The calling devices 206, 208, 210 may be movable about the building 200 such that, when moved, a dispatchable location of the calling device changes.

Depending on federal and/or local guidelines and/or the size(s) of floors of a building, floors (e.g., the first floor 202 and/or the second floor 204) of a building 200 may be subdivided into dispatchable location regions per floor. In the example shown in FIG. 2, the first floor 202 may be subdivided into six dispatchable location regions: northwest (NW) region 212, northcentral (NC) region 214, northeast (NE) region 216, southwest (SW) region 218, southcentral (SC) region 220, and southeast (SE) region 222. The second floor 204, as shown in FIG. 2, may be subdivided into four dispatchable location regions: NW region 224, NE region 226, SW region 228, SE region 230. Although the dispatchable location regions shown in FIG. 2 are based on compass directions, any other subdivision of a floor recognizable by emergency response personnel (which may be standardized based on federal and/or local guidelines) is appreciated. Further, although the first floor 202 and the second floor 204 shown in FIG. 2 include a specific number of subdivisions (e.g., six dispatchable location regions on the first floor 202 and four dispatchable location regions on the second floor 204), any floor may be subdivided into any number of dispatchable location regions.

When referring to an address of a calling device 206, 208, 210 for emergency response, as described herein, the address may include the building address of the building 200, the floor (e.g., the first floor 202 or the second floor 204), and the dispatchable location region at which the device is located. For example, as shown in FIG. 2, the address of a first calling device 206 is the building address of the building 200, the first floor 202, and the NC region 214. The address of a second calling device 208 is the building address of the building 200, the first floor 202, and the NE region 216. The address of a third calling device 210 is the building address of the building 200, the second floor 204, and the SW region 228. Thus, if a calling device moves buildings, moves between floors within a building 200, or moves to a different dispatchable location region on a floor of a building 200, then the address of the calling device changes. Detection of the change of address of a calling device and sending a prompt to the calling device for a user to update the address are further described herein.

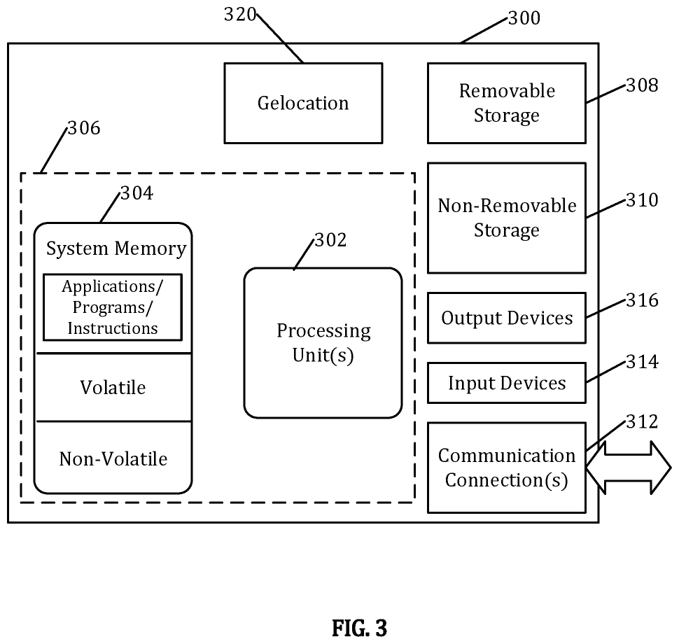

FIG. 3 depicts an example of a suitable operating environment 300 that may be implemented by a client device, system or server, and/or other computing devices within the systems discussed herein. In its most basic configuration, operating environment 300 typically includes at least one processing unit 302 and memory 304. The processing unit may be a processor, which is hardware. Depending on the exact configuration and type of computing device, memory 304 (storing, instructions to perform the motion detection techniques disclosed herein) may be volatile (such as RAM), non-volatile (such as ROM, flash memory, etc.), or some combination of the two. This most basic configuration is illustrated in FIG. 3 by dashed line 306. The memory 304 stores instructions that, when executed by the processing unit(s) 302, perform the processes and operations described herein, such as detecting if a device has moved, prompting correction of the address associated with that device, etc. Further, environment 300 may also include storage devices (removable 308, and/or non-removable 310) including, but not limited to, solid-state, magnetic disks, optical disks, or tape. Similarly, environment 300 may also have input device(s) 314 such as keyboard, mouse, pen, voice input, etc. and/or output device(s) 316 such as a display, speakers, printer, etc. Additional communication connections 312 may also be included that allow for further communication with LAN, WAN, point-to-point, etc. Operating environment 300 may also include geolocation devices 320, such as a global positioning system (GPS) device.

Operating environment 300 typically includes at least some form of computer readable media. Computer readable media can be any available media that can be accessed by processing unit 302 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media is non-transitory and does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of the any of the above should also be included within the scope of computer readable media.

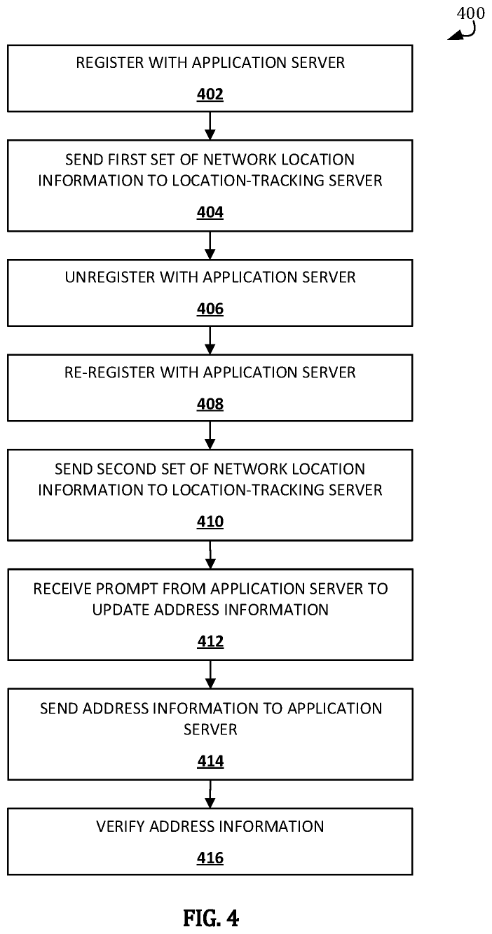

FIGS. 4, 5, and 6 show example methods according to the disclosed technology. The example methods include operations that may be implemented or performed by the systems and devices disclosed herein. For example, devices and servers in systems 100, 200, or 300 depicted in FIGS. 1, 2, and 3 may perform the operations described in the methods. In addition, instructions for performing the operations of the methods disclosed herein may be stored in a memory of a device or server described herein.

FIG. 4 depicts an example method 400 for device-location tracking for emergency calls, from a perspective of a calling device. At operation 402, a device (e.g., devices 104A, 104B, or calling devices 206, 208, 210) is registered at an application server (e.g., application server 106). Registration of the device with the application server may occur when the device is turned on and connected to a network (e.g., network 102). Registration of the device may be automatic. Additionally, registration of the device may include receiving a configuration file from the application server upon registration with the application server. The configuration file may include instructions to be carried out by the device. For example, the configuration file may instruct the device to retrieve a local IP address, set a VLAN identifier, and/or retrieve other configuration information and/or network location information associated with the device, network, and/or application server. For example, the configuration file may instruct the device to communicate network location information and/or device identification information, for the current registration period, to other devices and/or servers, such as a location-tracking server (e.g., location-tracking server 108).

At operation 404, a first set of network location information is sent to a location-tracking server. The network location information is associated with the device during a current registration period with the application server (e.g., during a time of uninterrupted registration of the device with the application server). Network location information may include a VLAN identifier, a local IP address, a BSSID, switch information, or other information associated with connectivity of the device to the network. Device identification information may also be sent to the location-tracking server, which may be used to identify the device. The network location information and/or device identification information may be determined by the device in response to executing instructions in the configuration file received during registration of the device at operation 402. The device may send the set of network information and/or device identification information to a location-tracking server or the application server. In an example where the network information is sent to the application server, the application server may then send the network location information to the location-tracking server. In an instance where the device sends the network location information to the location-tracking server, the device may be following an instruction received in a configuration file from the application server (e.g., the configuration file received during registration of the device may include instructions for the device to send network location information for the device to the location-tracking server).

At operation 406, the device becomes unregistered with the application server. The device may become unregistered if the device fails to respond to a ping or status request received from the application server. For example, the device may become unregistered if the device is no longer connected to the network, if the device turns off, if the device receives a software update, etc.

At operation 408, the device is re-registered with the application server. Re-registration may be the same or similar to registration of the device with the application as described at operation 402. For example, the device may register with the application server and receive a configuration file from the application server. The configuration file may be the same or different from the configuration file received at operation 402. For example, a device may receive a different configuration file for original registration with the application server and re-registration with the application server.

At operation 410, a second set of network location information is sent to the location-tracking server. Operation 410 may be similar to operation 404, described above. For example, the second set of network location information may be determined by the device in response to executing instructions in the configuration file received during re-registration of the device at operation 408. If the device has moved physical locations between registration and re-registration, then one or more components of the second set of network location information may be different from components of the first set of network location information (e.g., one or more of VLAN identifier, local IP address, BSSID, switch information, etc., may be different between the first set and second set of network location information).

At operation 412, a prompt is received from the application server to update address information. The address information is an address associated with the device for use during emergency calls. Address information may include dispatchable location information about the device, such as building address, floor, and/or position about a floor (e.g., SW corner, NC region, etc.), which may depend on federal and/or state guidelines. The prompt received from the application server at the device may instruct a user of the device to update the address information associated with the device at the application server. In examples, the prompt may be a voice call to the device (e.g., as initiated by the application server), an audio file played on the device (e.g., a .wav file saved at the device), a display of an instruction at a display of the device, etc.

At operation 414, address information is sent to the application server. A user of the device may communicate updated address information for the device to the application server, such as via a user portal, as a voice command in response to a voice call, etc. The address information may be communicated to the application server through the device.

At operation 416, the address information is verified and/or validated. The application server may verify and/or validate address information received about the device. For example, the application server may cross-check the address information against addresses listed in associated with emergency response locations, postal delivery locations, locations saved in a log file of the location-tracking server, or any other list of addresses or locations known to be valid for emergency response. If the address information does not match an address cross-checked by the application server, then the device or a user of the device may receive a verified list of address options similar to the address information provided. Verified address information may then be selected for the device. After the address information has been updated for the device, the device may receive a confirmation or receipt from the application server confirming that the address information associated with the device has been successfully updated.

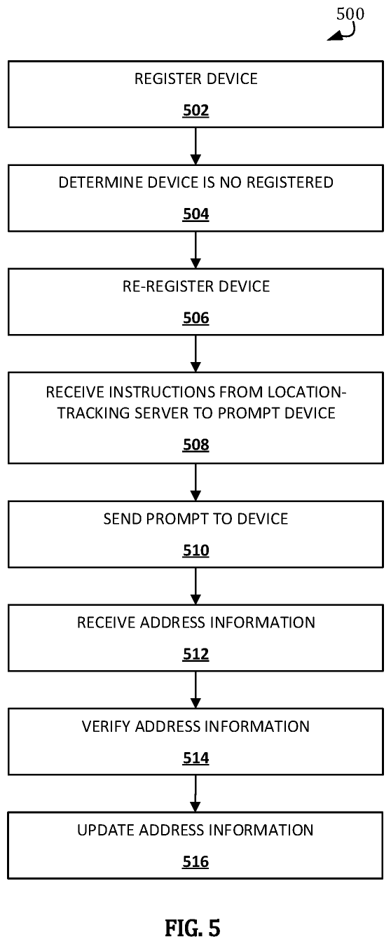

FIG. 5 depicts another example method 500 for device-location tracking for emergency calls, from a perspective of an application server. At operation 502, a device (e.g., devices 104A, 104B, or calling devices 206, 208, 210) is registered. Registration of the device may be made at an application server (e.g., application server 106). As described in operation 402 of FIG. 4, registration of the device with the application server may occur when the device is turned on and connected to a network (e.g., network 102). Registration of the device may be automatic. Upon registration of the device, the application server may send a configuration file to the device. The configuration file may include instructions to be carried out by the device.

At operation 504, a determination is made that the device is no longer registered. The application server may continuously or periodically ping or query a status of the device after registration of the device. If the device fails to respond to one or more pings or status requests sent by the application server, then the application server may determine that the device is no longer registered (e.g., the device is unregistered with the application server). When a device status changes from registered to unregistered, the application server may create an alert associated with the device. The alert may be associated with a specific configuration file to be sent to the device by the application server upon re-registration of the device. Additionally or alternatively, the alert may be sent to a location-tracking server (e.g., location-tracking server 108) to instruct the location-tracking server to query the device.

At operation 506, the device is re-registered. Re-registration of the device with the application server may be the same or similar to registration of the device with the application server as described at operation 502. For example, the device may register with the application server and receive a configuration file from the application server. The configuration file may be the same or different from the configuration file received at operation 502. For example, a device may receive a different configuration file for original registration with the application server and re-registration with the application server (e.g., a configuration file may be associated with an alert that the device has previously been unregistered with the application server).

At operation 508, instructions are received from a location-tracking server to prompt the device. Instructions to send a prompt to the device may be received from the location-tracking server when the location-tracking server detects that an address of the device has changed (e.g., network location information associated with the device has changed and thus indicated that the device has moved physical location). The instructions received from the location-tracking server to prompt the device includes instructions to prompt the device for updated or new address information about the device.

At operation 510, a prompt is sent to the device. The prompt sent from the application server to the device may include instructions for a user of the device to update address information associated with the device. As described herein, address information may include dispatchable location information about the device, such as building address, floor, and/or position about a floor, which may depend on federal and/or state guidelines. The prompt sent by the application server to the device may be a voice call to the device (e.g., as initiated by the application server), an audio file played on the device (e.g., an instruction for the device to play a .wav file saved at the device), a display of a visual indicator at a display of the device (e.g., an instruction for the device to display the prompt), etc.

At operation 512, address information is received. The address information may be received from the device or from a user of the device. At operation 514, the address information is verified and/or validated. As described herein, the application server may verify and/or validate address information received about the device. For example, the application server may cross-check the address information against addresses in a list or log. If the address information provided in response to the prompt does not match an address cross-checked by the application server, then a verified list of address options similar to the address information may be provided by the application server for selection.

The verified/validated address information is then updated at operation 516. The verified/validated address information may be stored at the application server. Additionally, the address information may be provided to the location-tracking server for storage in associated with a set of network location information. After the address information has been updated, the application server may send a confirmation or receipt to the device confirming that the address information associated with the device has been successfully updated.

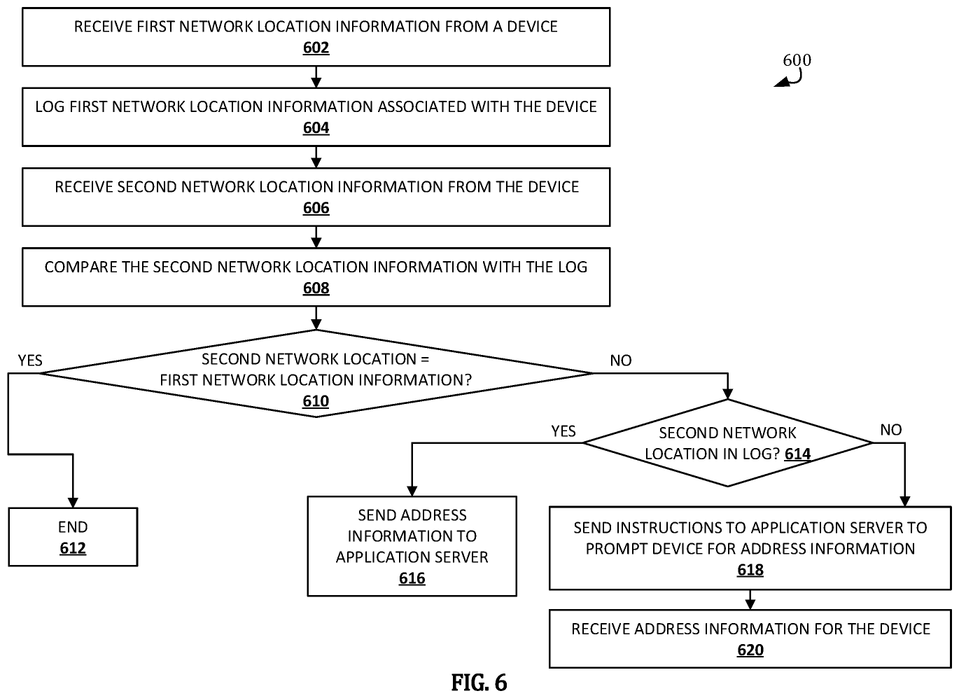

FIG. 6 depicts another example method 600 for device-location tracking for emergency calls, from a perspective of a location-tracking server. At operation 602, first network location information (e.g., a first set of network location information) is received from a device (e.g., devices 104A, 104B, or calling devices 206, 208, 210). The first network location information may be associated with a device. Association with a device may be determined based on device identification information also received from the device. Additionally, the first network location information may be associated with a first registration period of the device with an application server (e.g., application server 106). The first network location information may include one or more of a VLAN identifier, a local IP address, a BSSID, and/or switch information. The first network location information may be sent from the device during execution of a configuration file received at the device during registration with the application server. Alternatively, the first network location information may be requested by the location-tracking server.

At operation 604, the first network location information is logged in a log. For example, the location-tracking server may store the first network location information in a log at the location-tracking server. The first network location information may be stored along with an association with a device, a temporal indicator (e.g., the most recent network location information received from the device, the immediately preceding network location information for the device, network location information received prior to the immediately preceding network location information, etc.), and/or address information.

At operation 606, second network location information is received from the device. The second network location information may be received in a manner similar to the first network location information at operation 602. The second network location information may be associated with a second registration period of the device with an application server (e.g., re-registration of the device with the application server after the device became unregistered). Similar to the first network location information, the second network location information may include one or more of a VLAN identifier, a local IP address, a BSSID, and/or switch information.

At operation 608, the second network location information is compared with the log. For example, the location-tracking server may compare the second network location information with the first network location information and/or other network location information stored in the log of the location-tracking server.

At determination 610, it is determined if the second network location information is the same as the first network location information. In an example, the first network location information is from a first registration period of the device immediately preceding a second registration period of the device during which the second network location information was received. If all portions of the second network location information match all portions of the first network location information, then the location-tracking server determines that that second network location information is the same as the first network location information. If, alternatively, any portion of the second network location information does not match any portion of the first network location information, then the location-tracking server determines that the second network location information is not the same as the first network location information. For example, if the first and second network location information include a VLAN identifier and a local IP address, for the first network location information and the second network location information to be the same, the VLAN identifier and local IP address of the first network location information must be the same as the VLAN identifier and local IP address of the second network location information. Thus, if any of the VLAN identifier and local IP address of the first network location information do not match the VLAN identifier and local IP address, respectively, of the second network location information, then the first network location information is not the same as the second network location information.

If it is determined that the second network location information is the same as the first network location information, then flow proceeds “YES” to operation 612. In particular, a determination along this path indicates that an address of the device has not changed, because the network location information of the device has not changed between consecutive registration periods (e.g., the second network location information is the same as the first network location information). At operation 612, no further action is taken by the location-tracking server.

If, alternatively, the second network location information is not the same as the first network location information, then flow proceeds “NO” to determination 614. Flow along this path indicates that the device has moved and that a physical address (e.g., dispatchable location) of the device may have changed. At determination 614, it is determined if the second network location information is in the log. For example, the location-tracking server may compare the second network location information to other network location information stored in the log (e.g., other than the first network location information). If the second network location information is the same as a set of previously logged network location information, then a determination is made that the second network location is in the log. The comparison of the second network information to previously logged network location information may be similar to the comparison described with respect to determination 610.

If it is determined that the second network location information is the same as previously logged network location information stored in the log (e.g., other than the first network location information), then flow proceeds “YES” to operation 616. A determination along this path indicates that an address of the device may be known, despite the device being moved, based on previously logged network location information associated with verified address information (which may be received from the application server). For example, referring to Device 1 in Table 2, above, if Set 1 is the same as any of the previously logged Sets 4-7, which are associated with verified address information, then the address information for Set 1 is known, even if Set 1 does not match the immediately preceding Set 3 for Device 1. As another example, referring to Device 2 in Table 2, above, if Set 2 is the same as any of previously logged Sets 3 or 5-7, which are associated with verified address information, then the address information for Set 2 is known, even if Set 2 does not match the immediately preceding Set 4 for Device 2.

At operation 616, address information associated with the matched set of previously logged network location information is sent to the application server. Because verified address information associated with the second network location information is known, address information need not be obtained from a user of the device. As otherwise required or desired, however, the application server may verify the address information by prompting the device (e.g., as described with respect to operations 412 and 508-510). In an example, the address information stored in the log of the location-tracking server may be verified if a minimum time as passed since address information associated with the previously logged network location information has been verified and/or validated (e.g., at least two months, six months, a year, or two or more years).

If, alternatively, the second network location information does not match any previously logged network location information, then flow proceeds “NO” to operation 618. At operation 618, instructions are sent to an application server to prompt the device for address information. For example, the location-tracking server may send an alert or instructions to the application server indicating that address information for the device may be inaccurate and to prompt the device to update address information associated with the device. Prompting of the device by the application server is further described herein at least with respect to operations 508-510.

At operation 620, address information for the device is received. The location-tracking server may receive address information for the device associated with the second network location information from the application server or the device. In an example, after address information has been verified and/or validated by the application server, the application server may send the address information to the location-tracking server for storage in the log. Additionally or alternatively, the application server and/or the location-tracking server may query the device to send address information directly to the location-tracking server (e.g., before or after verification and/or validation by the application server).

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure. In addition, some aspects of the present disclosure are described above with reference to block diagrams and/or operational illustrations of systems and methods according to aspects of this disclosure. The functions, operations, and/or acts noted in the blocks may occur out of the order that is shown in any respective flowchart. For example, two blocks shown in succession may in fact be executed or performed substantially concurrently or in reverse order, depending on the functionality and implementation involved.

This disclosure describes some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art. Further, as used herein and in the claims, the phrase “at least one of element A, element B, or element C” is intended to convey any of: element A, element B, element C, elements A and B, elements A and C, elements B and C, and elements A, B, and C. Further, one having skill in the art will understand the degree to which terms such as “about” or “substantially” convey in light of the measurement techniques utilized herein. To the extent such terms may not be clearly defined or understood by one having skill in the art, the term “about” shall mean plus or minus ten percent.

Although specific embodiments are described herein, the scope of the technology is not limited to those specific embodiments. Moreover, while different examples and embodiments may be described separately, such embodiments and examples may be combined with one another in implementing the technology described herein. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

What is claimed is:

1. A computer-implemented method for location tracking of a device for emergency calls, the computer-implemented method comprising:
receiving a first set of network location information from a device;
logging the first set of network location information in a log;
receiving a second set of network location information from the device;
comparing the first set of network location information with the second set of network location information;
determining that the first set of network location information is different from the second set of network location information; and
in response to determining that the first set of network location information is different from the second set of network location information, sending a notification to verify address information for the device.

2. The computer-implemented method of claim 1, the method further comprising:
logging the second set of network location information in the log.

3. The computer-implemented method of claim 1, the method further comprising:
in response to the notification to verify the address information for the device, receiving address information for the device; and
logging the address information in the log in association with the second set of network location information.

4. The computer-implemented method of claim 1, wherein the first set of network location information is associated with a first registration period of the device and the second set of network location information is associated with a second registration period of the device different from the first registration period.

5. The computer-implemented method of claim 4, wherein the first registration period immediately precedes the second registration period for the device.

6. The computer-implemented method of claim 1, wherein the first set of network location information and the second set of network location information each include one or more of:
a virtual local area network (VLAN) identifier;
a local internet protocol (IP) address;
a basic service set identifier (BSSID); or
switch information.

7. The computer-implemented method of claim 1, wherein the log includes at least one previously logged set of network location information associated with verified address information.

8. The computer-implemented method of claim 7, the method further comprising:
comparing the second set of network location information with the previously logged set of network location information; and
determining that the second set of network location information is different from the previously logged set of network location information.

9. A computer-implemented method for location tracking of a device for emergency calls, the computer-implemented method comprising:
receiving a first set of network location information from a device;
logging the first set of network location information in a log, wherein the log further includes a set of previously logged network location information different from the first set of network location information and wherein the set of previously logged network location information is associated with address information;
receiving a second set of network location information from the device;
comparing the second set of network location information with the first set of network location information and the previously logged set of network location information;
determining that the second set of network location information is the same as the set of previously logged network location information;
associating the second set of network location information with the device and the address information; and
logging the second set of network location information in the log.

10. The computer-implemented method of claim 9, wherein the second set of network location information is received from the device consecutively after the first set of network location information.

11. The computer-implemented method of claim 9, wherein the device is a first device and wherein the set of previously logged network location information is associated with a second device.

12. The computer-implemented method of claim 11, the method further comprising:
receiving first device identification information from the first device; and
receiving first device identification information from the second device, wherein association of the second set of network location information with the first device is based on the first device identification information and association of the second set of network location information with the second device is based on the second device identification information.

13. The computer-implemented method of claim 9, wherein the address information is validated.

14. The computer-implemented method of claim 13, wherein the address information is a dispatchable location of the device.

15. A computer-implemented method for location tracking of a device for emergency calls, the computer-implemented method comprising:
registering a device during a first registration period;
in response to registering the device, sending first instructions to the device to cause the device to send a first set of network location information to a server, wherein the first set of network location information is associated with the first registration period;
determining that the device is no longer registered;
re-registering the device during a second registration period;
in response to re-registering the device, sending second instructions to the device to cause the device to send a second set of network location information to the server, wherein the second set of network location information is associated with the second registration period; and
based on the first set of network location information and the second set of network location information being different, sending a prompt to the device to update address information associated with the device.

16. The computer-implemented method of claim 15, wherein the first registration period immediately precedes the second registration period.

17. The computer-implemented method of claim 15, wherein sending the prompt to the device is further based on an indication received from the server.

18. The computer-implemented method of claim 15, wherein the prompt is one of:
a voice call to the device;
an audio file to be played by the device; or
a visual indicator displayed by the device.

19. The computer-implemented method of claim 15, the method further including:
receiving address information from the device, in response to the prompt.

20. The computer-implemented method of claim 19, the method further including:
validating the address information; and
updating the address information for the device.
